(19) United States
(12) Patent Application Publication
(10) Pub. No.: US 2014/0125151 A1
(43) Pub. Date: May 8, 2014

(54) POWER GENERATOR

(71) Applicant: MITSUMI ELECTRIC CO., LTD., Tokyo (JP)

(72) Inventors: KENICHI FURUKAWA, Sagamihara-shi (JP); KENSUKE YAMADA, Tokyo (JP)

(73) Assignee: MITSUMI ELECTRIC CO., LTD., Tokyo (JP)

(21) Appl. No.: 14/069,128

(22) Filed: Oct. 31, 2013

(30) Foreign Application Priority Data
Nov. 2, 2012 (JP) 2012-242330

(51) Int. Cl. H02K 35/02

(52) U.S. Cl. CPC H02K 35/02
USPC 310/25

(57) ABSTRACT

A power generator 100 of the present invention includes a housing 20; a permanent magnet 31 disposed in the housing 20 so that the permanent magnet 31 can be displaced in a magnetization direction thereof; a coil 40 disposed in the housing 20 so as to surround the permanent magnet 31 without contacting with the magnet 39; a coil holding portion 50 disposed between the housing 20 and the permanent magnet 31; a pair of leaf springs 60U, 60L disposed in the housing 20 so as to be opposed to each other through at least the permanent magnet 31, the coil 40 and the coil holding portion 50; and at least one of a first spring constant adjuster 12 for adjusting spring constants of the first spring portions 64 and a second spring constant adjuster 13 for adjusting spring constants of the second spring portions 65.

### BACKGROUND OF THE INVENTION

1. Field of the Invention

The present invention relates to a power generator.

2. Description of the Prior Art

Recently, various power generators generating electric power by converting vibration energy into electric energy are developed. For example, see a patent document 1 (JP 2011-160548A). A power generator disclosed in the patent document 1 has a main unit for generating electric power and a pair of coil springs provided on the same axis with each other. The power generator is configured to vibrate the main unit by using the pair of coil springs. In the power generator, it is possible to displace a magnet provided in the main unit relative to a coil by utilizing the vibration. As a result, electric voltage is induced in the coil due to electromagnetic induction.

In such power generator, it is possible to adjust a resonant frequency of the power generator (main unit) by some ways such as adding a weight to the main unit and changing the coil spring and/or the coil. In such power generator, there is a case where the resonant frequency of the power generator changes from a predetermined (desired) frequency due to some factors. However, it is difficult to readjust the resonant frequency of the power generator after the power generator has been assembled because cumbersome and complicated processes (for example, disassembly process) are required to readjust the resonant frequency of the power generator.

### SUMMARY OF THE INVENTION

The present invention has been made in view of the problems mentioned above. Accordingly, it is an object of the present invention to provide a power generator whose resonant frequency can be easily and reliably adjusted when the resonant frequency of the power generator changes from a predetermined frequency.

In order to achieve the object, the present invention is directed to a power generator configured to be used in a state that the power generator is fixedly attached to a vibrating body. The power generator includes a housing; a magnet disposed in the housing so that the magnet can be displaced in a magnetization direction thereof; a coil disposed in the housing so as to surround the magnet without contacting with the magnet; a coil holding portion disposed between the housing and the magnet, the coil holding portion holding the coil so that the coil can be displaced relative to the magnet in the magnetization direction of the magnet; a pair of leaf springs disposed in the housing so as to be opposed to each other through at least the magnet, the coil and the coil holding portion, each of the leaf springs having a plurality of first spring portions coupling the housing with the coil holding portion and a plurality of second spring portions coupling the coil holding portion with the magnet; and at least one of a first spring constant adjuster for adjusting spring constants of the first spring portions and a second spring constant adjuster for adjusting spring constants of the second spring portions. When the power generator is fixedly attached to the vibrating body, the power generator is configured to generate electric power by utilizing vibration of the vibrating body.

In the power generator according to the present invention, it is preferred that each of the leaf springs includes a first circular portion; a second circular portion arranged on the inner side of the first circular portion concentrically with the first circular portion and coupled with the first circular portion through the first spring portions; and a third circular portion arranged on the inner side of the second circular portion concentrically with the second circular portion and coupled with the second circular portion through the second spring portions. Further, the housing holds the first circular portions of the leaf springs, the coil holding portion is supported between the second circular portions of the leaf springs and the magnet is supported between the third circular portions of the leaf springs.

In the power generator according to the present invention, it is preferred that the first spring portions include a plurality of first spring portions arranged so as to be rotationally symmetric around a central axis of the third circular portion. Further, the first spring constant adjuster is configured to adjust the spring constants of the symmetrically arranged first spring portions all together.

In the power generator according to the present invention, it is preferred that each of the first spring portions of the leaf springs has one end portion coupled with the first circular portion and another end portion coupled with the second circular portion. Further, the first spring constant adjuster has clipping members for respectively clipping clipped portions provided around the one end portions of the first spring portions. Furthermore, the first spring constant adjuster is configured to adjust the spring constants of the first spring portions by sliding the clipped portions of the one end portions.

In the power generator according to the present invention, it is preferred that the clipped portions of the one end portions of the first spring portions are configured to be slid by rotating the pair of leaf springs relative to the housing around the central axis of the third circular portion.

In the power generator according to the present invention, it is preferred that the power generator further includes a manipulating mechanism for rotating the pair of leaf springs relative to the housing.

In the power generator according to the present invention, it is preferred that the clipping members are integrally formed with the housing.

In the power generator according to the present invention, it is preferred that the second spring constant adjuster has a clearance adjuster for adjusting a clearance between the third circular portions of the leaf springs and is configured to be capable of adjusting the spring constants of the second spring portions by changing the clearance between the third circular portions of the leaf springs with the clearance adjuster.

In the power generator according to the present invention, it is preferred that the clearance adjuster has a spacer fixed on the third circular portion of one of the leaf springs, a clearance adjusting member for adjusting a clearance between the spacer and the magnet and an elastic member disposed between the spacer and the magnet.

In the power generator according to the present invention, it is preferred that a vibrating system due to the elastic member is provided in the power generator. Further, the vibrating system has a resonant frequency larger than five times a frequency of vibration utilized for power generation of the power generator.

In the power generator according to the present invention, it is preferred that the elastic member is a spring washer or a wave washer.

### Effect of the Invention

According to the power generator of the present invention, it is possible to easily and reliably adjust the resonant frequency of the power generator with simple manipulation.

### BRIEF DESCRIPTION OF THE DRAWINGS

FIG. 1 is a perspective view showing a power generator according to a first embodiment of the present invention.

FIG. 2 is an exploded perspective view showing the power generator shown in FIG. 1.

FIG. 3 is a cross-sectional view taken along an A-A line in FIG. 1 (a longitudinal cross-sectional view showing a main unit shown in FIG. 2).

FIG. 4 is a planar view showing a leaf spring of the main unit shown in FIG. 2.

FIG. 5 is a graph for explaining an effect due to change of a resonant frequency.

FIG. 6 is a perspective view showing a structure of a first spring constant adjuster.

FIG. 7 is a perspective view showing a structure of the first spring constant adjuster.

FIG. 8 is a planar view showing a structure of the first spring constant adjuster.

FIG. 9 is a stress distribution map showing a stress distribution of a first spring portion of the leaf spring shown in FIG. 4 (FIG. 9a is an overall view and FIG. 9b is an enlarged view showing the vicinity of one end portion of the first spring portion).

FIG. 10 is a planar view for explaining an action of the first spring constant adjuster.

FIG. 11 is a planar view showing a structure of a manipulating mechanism.

FIG. 12 is a planar view showing the structure of the manipulating mechanism.

FIG. 13 is a cross-sectional view taken along with a B-B line in FIG. 12 (a longitudinal cross-sectional view showing the structure of the manipulating mechanism).

FIG. 14 is a perspective view showing a first spring constant adjuster according to a second embodiment of the present invention.

FIG. 15 is a perspective view showing the first spring constant adjuster according to the second embodiment of the present invention.

FIG. 16 is a planar view showing the first spring constant adjuster according to the second embodiment of the present invention.

FIG. 17 is a planar view for explaining an action of the first spring constant adjuster according to the second embodiment of the present invention.

FIG. 18 is a perspective view showing a structure of a second spring constant adjuster.

FIG. 19 is a longitudinal cross-sectional view showing a structure of the second spring constant adjuster.

FIG. 20 is a longitudinal cross-sectional view for explaining an action of the second spring constant adjuster.

FIG. 21 is a graph for explaining change of spring constants of second spring portions.

### DETAILED DESCRIPTION OF THE PREFERRED EMBODIMENTS

Hereinafter, power generators according to a first embodiment to a third embodiment of the present invention will be described below with reference to the accompanying drawings.

### First Embodiment

Description will be first given to a power generator 100 according to the first embodiment of the present invention.

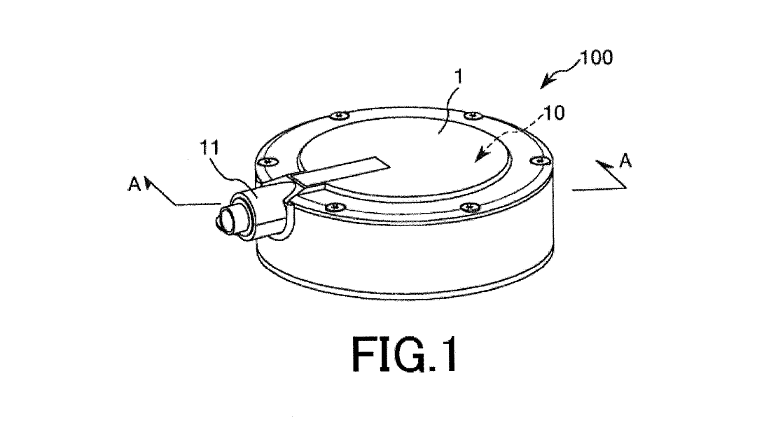

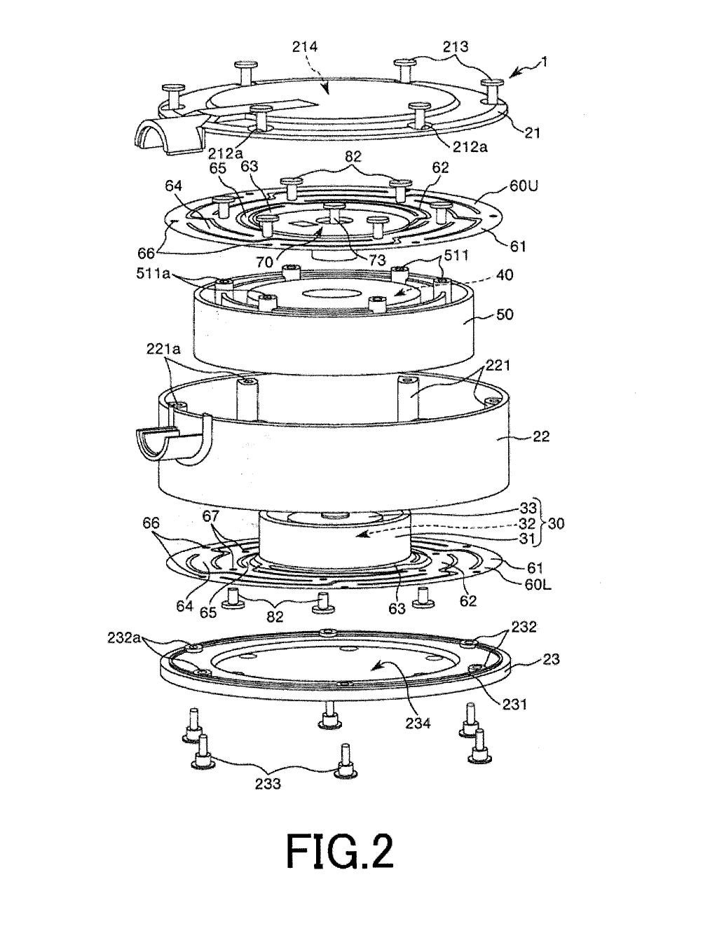

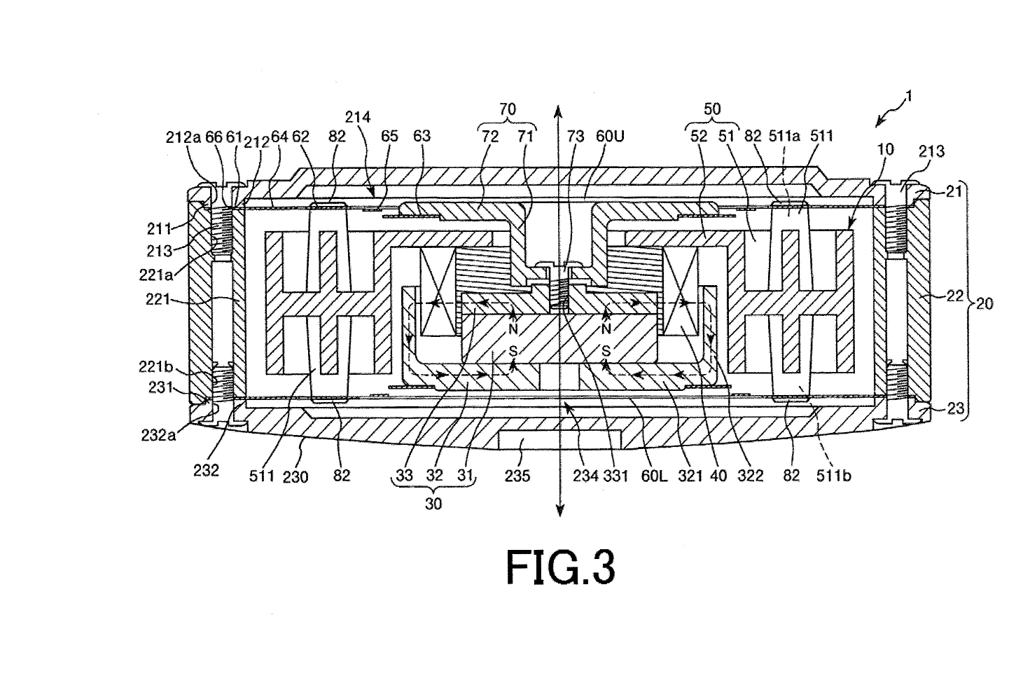

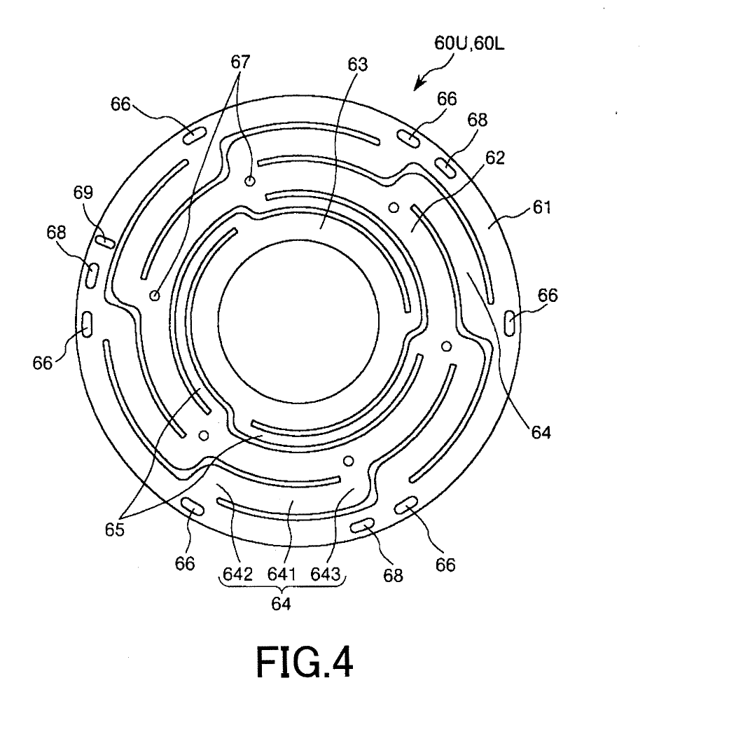

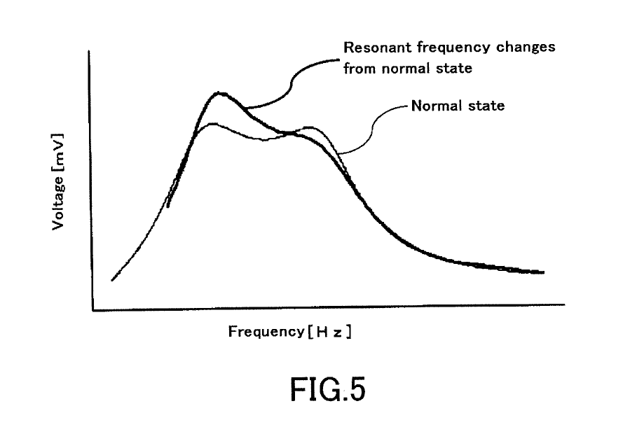

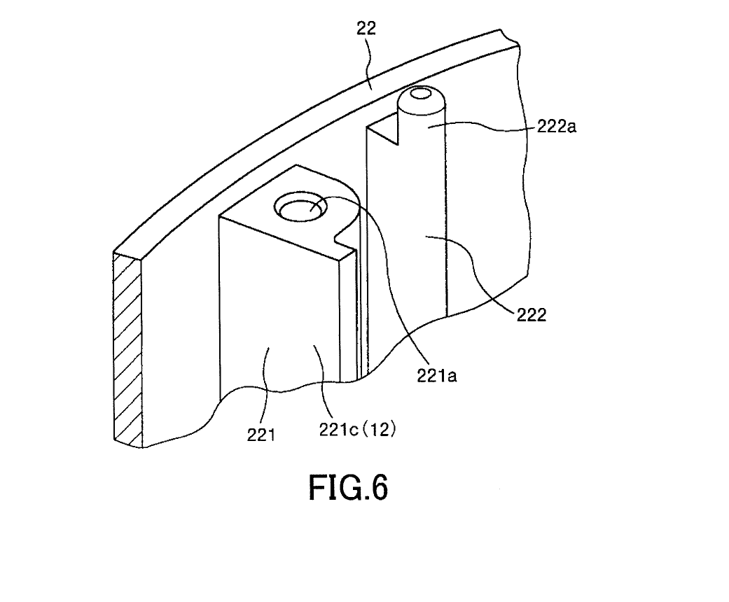

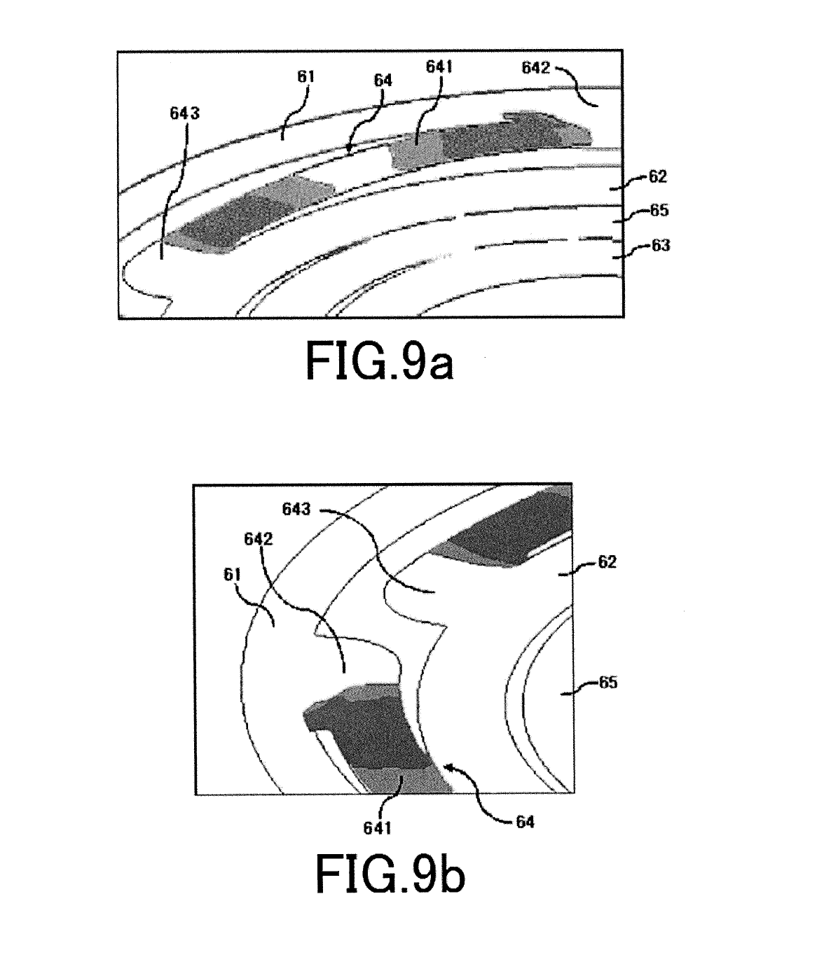

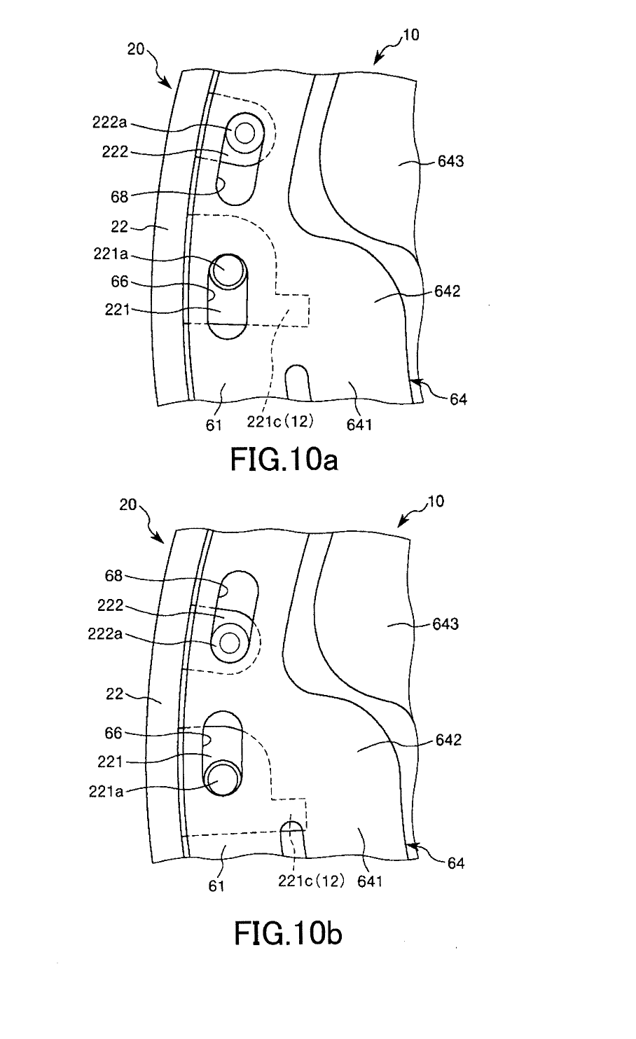

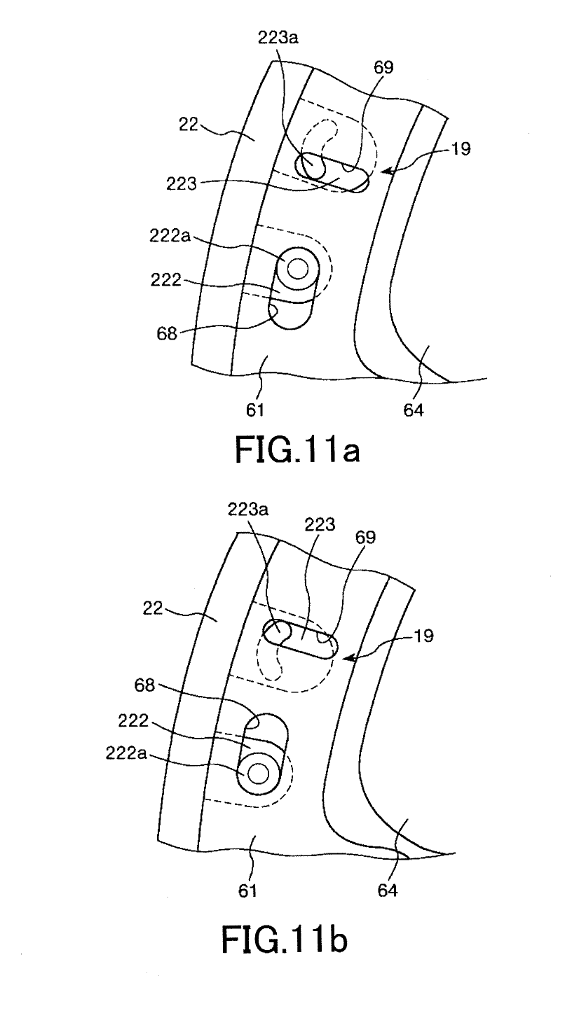

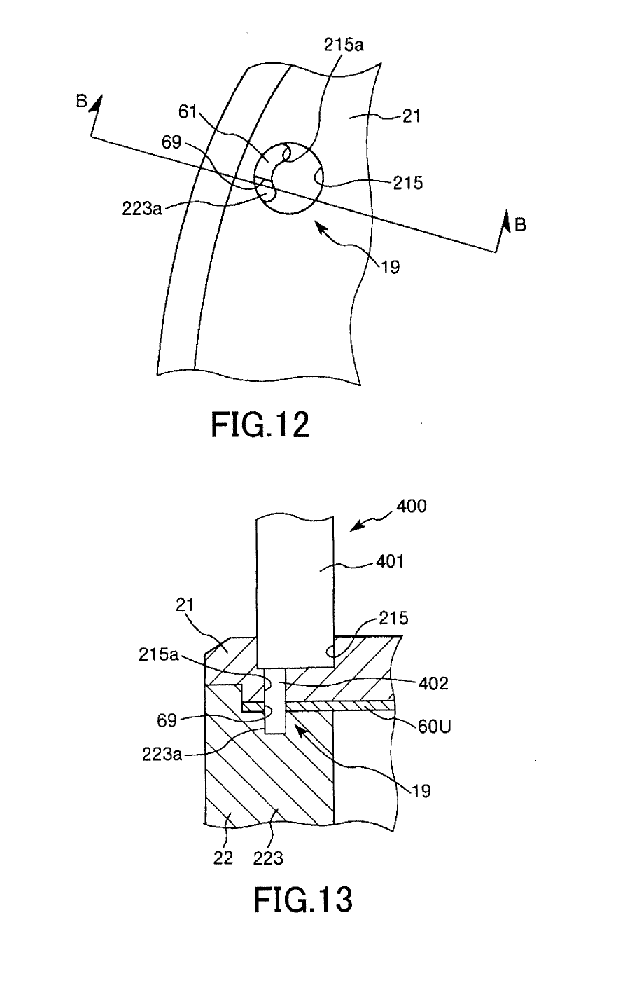

FIG. 1 is a perspective view showing the power generator 100 according to the first embodiment of the present invention. FIG. 2 is an exploded perspective view showing the power generator 100 shown in FIG. 1. FIG. 3 is a cross-sectional view taken along an A-A line in FIG. 1 (a longitudinal cross-sectional view showing a main unit shown in FIG. 2). FIG. 4 is a planar view showing a leaf spring of the main unit shown in FIG. 2. FIG. 5 is a graph for explaining an effect due to change of a resonant frequency. Each of FIGS. 6 to 8 is a perspective view showing a structure of a first spring constant adjuster. FIG. 9 is a stress distribution map showing a stress distribution of a first spring portion of the leaf spring shown in FIG. 4 (FIG. 9a is an overall view and FIG. 9b is an enlarged view showing the vicinity of one end portion of the first spring portion). FIG. 10 is a planar view for explaining an action of the first spring constant adjuster. FIG. 11 is a planar view showing a structure of a manipulating mechanism. FIG. 12 is a planar view showing the structure of the manipulating mechanism. FIG. 13 is a cross-sectional view taken along with a B-B line in FIG. 12 (a longitudinal cross-sectional view showing the structure of the manipulating mechanism).

Hereinafter, an upper side in each of FIGS. 1 to 3, 6 and 13 is referred to as “upper” or “upper side” and a lower side in each of FIGS. 1 to 3, 6 and 13 is referred to as “lower” or “lower side”. Further, a front side of the paper in each of FIGS. 4, 8 and 10 to 12 is referred to as “upper” or “upper side” and a rear side of the paper in each of FIGS. 4, 8 and 10 to 12 is referred to as “lower” or “lower side”.

The power generator 100 shown in FIGS. 1 and 2 is configured to be used in a state that the power generator 100 is fixedly attached to a vibrating body (base body). The power generator 100 has a main unit 1, an attachment (not shown) for fixedly attaching the main unit 1 to the vibrating body and a connector 11 to be coupled to an external device. When the power generator 100 is attached to the vibrating body through the attachment, the main unit 1 (power generator 100) is configured to generate electric power by utilizing vibration of the vibrating body.

As shown in FIGS. 1 to 3, the main unit 1 includes a housing 20, a power generating unit 10 supported in the main unit 1 so that the power generating unit 10 can be vibrated in a vertical direction in FIG. 3. The power generating unit 10 has a pair of an upper leaf spring 60U and a lower leaf spring 60L opposed to the upper leaf spring 60U, a magnet assembly 30 supported between the pair of leaf springs 60U, 60L and having a permanent magnet 31, a coil 40 disposed so as to surround the permanent magnet 31 and a coil holding portion 50 holding the coil 40. In this embodiment, the upper leaf spring 60U and the lower leaf spring 60L have a shape substantially identical to each other.

<<Housing 20>>

As shown in FIGS. 2 and 3, the housing 20 has a cover 21, a base (support board) 23 supporting the power generating unit 10 on an upper side (one surface side) of the base 23 and a cylindrical portion 22 provided between the cover 21 and the base 23.

The cover 21 is formed into a roughly discoid shape which includes a circular portion and an annular lib (a ring-shaped lib) 211 integrally formed around a periphery of the circular portion so as to downwardly protrude from the periphery of the circular portion. Six boss sections 212 are formed in the lib 211 along with an inner peripheral portion of the lib 211 at substantially regular intervals. Through-holes 212a are respectively formed in the boss sections 212. Further, a concave portion (runoff) 214 is defined by the cover 21 on the inner side of the lib 211 so as to downwardly open. Since the power generating unit 10 can be displaced (retracted) in the concave portion 214 at the time of vibration, it is possible to prevent the power generating unit 10 from contacting with the cover 21 (circular portion).

The cylindrical portion 22 has a cylindrical shape with an outer diameter thereof substantially equal to an outer diameter of the cover 21 in a planer view. When the power generating unit 10 is assembled in the housing 20 (hereinafter, this state is referred to as “assembled state”), a main part of the power generating unit 10 which contributes to power generation is disposed in the cylindrical portion 22.

Six boss sections 221 are formed on an inner circumferential surface of the cylindrical portion 22 so as to extend along with a height direction of the cylindrical portion 22 (the vertical direction) and respectively correspond to the boss sections 212 of the cover 21. Upper threaded holes 221a are respectively formed on upper ends of the boss sections 221. In addition, six through-holes 66 are formed in a peripheral portion of each of the upper leaf spring 60U and the lower leaf spring 60L (that is, first circular portions 61 of the leaf springs 60U, 60L which will be explained below) along with a circumferential direction of each of the leaf springs 60U, 60L at substantially regular intervals.

The peripheral portion of the upper leaf spring 60U is disposed between the cover 21 and the cylindrical portion 22, and then screws 213 are respectively screwed into the upper threaded holes 221a of the boss sections 221 passing through the through-holes 212a of the cover 21 and the through-holes 66 of the upper leaf spring 60U. This makes it possible to fixedly hold the peripheral portion of the upper leaf spring 60U between the cover 21 and the cylindrical portion 22.

The base 23 is formed into a roughly discoid shape which includes a circular portion and an annular lib (a ring-shaped lib) 231 integrally formed around a peripheral portion of the circular portion so as to upwardly protrude from the peripheral portion of the circular portion. Six boss sections 232 are formed in the lib 231 along with an inner peripheral portion of the lib 231 at substantially regular intervals. Through-holes 232a are respectively formed in the boss sections 232. Further, a concave portion (runoff) 234 is defined by the base 23 on the inner side of the lib 231 so as to upwardly open. Since the power generating unit 10 can be displaced (retracted) in the concave portion 234 at the time of vibration, it is possible to prevent the power generating unit 10 from contacting with the base 23.

In addition, four threaded holes (female screws) 221b are respectively formed on lower ends of the boss sections 221 of the cylindrical portion 22. The peripheral portion of the lower leaf spring 60L (that is, the first circular portion 61) is disposed between the base 23 and the cylindrical portion 22, and then screws 233 are respectively screwed into the lower threaded holes 221b of the boss sections 221 passing through the through-holes 232a of the base 23 and the through-holes 66 of the lower leaf spring 60L. This makes it possible to fixedly hold the peripheral portion of the lower leaf spring 60L between the base 23 and the cylindrical portion 22.

As shown in FIG. 3, a lower surface (other surface) 230 of the base 23 forms a curved convex surface downwardly protruding. On the other hand, a concave portion 235 is formed on the lower surface 230 of the base 23 so as to receive the attachment (not shown) and the like.

A constituent material of the housing 20 (the cover 21, the cylindrical portion 22 and the base 23) is not limited to a specific material, but examples of the constituent material include a metallic material, a ceramic material, a resin material and a combination of two or more of the above materials.

A width of the housing 20 (base 23) is not limited to a specific value, but preferably in the range of about 60 to 120 mm from the view point of downsizing the power generator 100. An average height of the housing 20 is not limited to a specific value, but preferably in the range of about 20 to 50 mm, and more preferably in the range of about 30 to 40 mm from the viewpoint of reducing the height of the power generator 100.

The power generating unit 10 is supported in the housing 20 by the upper leaf spring 60U and the lower leaf spring 60L so that the power generating unit 10 can be vibrated.

<<Upper Leaf Spring 60U and Lower Leaf Spring 60L>>

The upper leaf spring 60U is fixedly held between the cover 21 and the cylindrical portion 22 in a state that the peripheral portion of the upper leaf spring 60U is clipped by the cover 21 and the cylindrical portion 22. The lower leaf spring 60L is fixedly held between the base 23 and the cylindrical portion 22 in a state that the peripheral portion of the lower leaf spring 60L is clipped by the base 23 and the cylindrical portion 22.

Each of the leaf springs 60U, 60L is a circular component formed of a metallic-thin plate such as an iron plate and a stainless steel plate. As shown in FIG. 4, each of the leaf springs 60U, 60L has the first circular portion 61 having a first inner diameter, a second circular portion 62 having a second inner diameter smaller than the first inner diameter of the first circular portion 61 and a third circular portion 63 having a third inner diameter smaller than the second inner diameter of the second circular portion 62. In each of the leaf springs 60U, 60L, the first circular portion 61, the second circular portion 62 and the third circular portion 63 are arranged from the outside to the inside thereof in this order.

Further, the first circular portion 61, the second circular portion 62 and the third circular portion 63 are arranged concentrically in each of the leaf springs 60U, 60L. The first circular portion 61 is coupled with the second circular portion 62 through a plurality of first spring portions 64 (in this embodiment, the number of the first spring portions 64 is six). The second circular portion 62 is coupled with the third circular portion 63 through a plurality of second spring portions 65 (in this embodiment, the number of the second spring portion 65 is three).

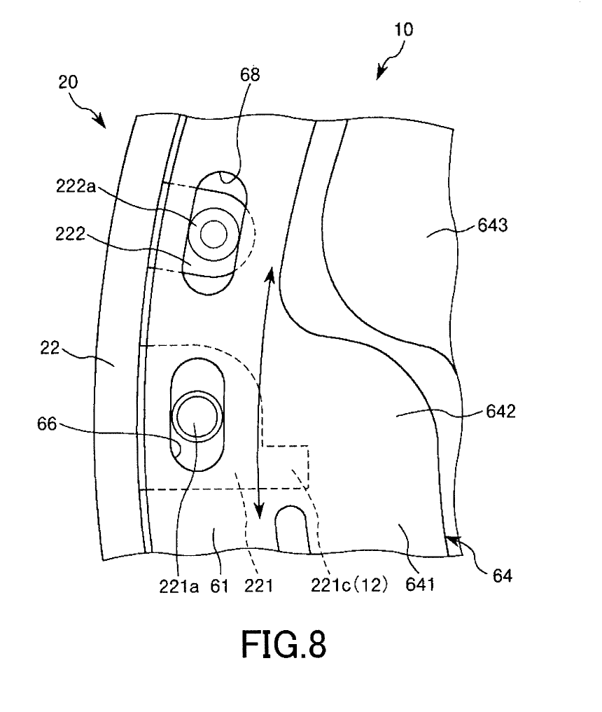

The six through-holes 66 are formed in the first circular portion 61 of each of the leaf springs 60U, 60L along with a circumferential direction of the first circular portion at substantially regular intervals (at regular angular-intervals of about 60 degree). As shown in FIGS. 4 and 8, each of the through-holes 66 is an elliptic hole (slot) extending along with the circumferential direction of the first circular portion 61. As explained above, the screws 213 are respectively screwed into the upper threaded holes 221a of the boss sections 221 passing through the through-holes 66 of the upper leaf spring 60U. On the other hand, the screws 233 are respectively screwed into the lower threaded holes 221b of the boss sections 221 passing through the through-holes 66 of the lower leaf spring 60L.

Further, six through-holes 67 are formed in the second circular portion 62 of each of the leaf springs 60U, 60L along with a circumferential direction of the second circular portion 62 at substantially regular intervals (at regular angular-intervals of about 60 degree). Furthermore, the coil holding portion 50 (which will be explained below) has six boss sections 511 formed along with a circumferential direction of the coil holding portion 50 so as to extend in the vertical direction. Upper threaded holes 511a are respectively formed on upper ends of the boss sections 511. Lower threaded holes 511b are respectively formed on lower ends of the boss sections 511.

Screws 82 are respectively screwed into the upper threaded holes 511a of the boss sections 511 passing through the through-holes 67 of the upper leaf spring 60U. This makes it possible to couple the second circular portion 62 of the upper leaf spring 60U with the coil holding portion 50. In the same manner, the other screws 82 are respectively screwed into the lower threaded holes 511b of the boss sections 511 passing through the through-holes 67 of the lower leaf spring 60L. This makes it possible to couple the second circular portion 62 of the lower leaf spring 60L with the coil holding portion 50.

A spacer 70 disposed above the magnet assembly 30 is coupled with the third circular portion 63 of the upper leaf spring 60U. On the other hand, the magnet assembly 30 is coupled with the third circular portion 63 of the lower leaf spring 60L. In this embodiment, the spacer 70 is coupled with the magnet assembly 30 by a screw 73.

Each of the six first spring portions 64 in the leaf springs 60U, 60L has an arch-shaped portion 641 (a substantially sigmoidal shape). Each of the first spring portions 64 is arranged in a space between the first circular portion 61 and the second circular portion 62. In more detail, three pairs of the first spring portions 64 are arranged so as to be opposed to each other through the second circular portion 62 (the coil holding portion 50). The three pairs of first spring portions 64 are arranged so as to be rotational symmetric with each other around a central axis of the third circular portion 63.

Each of the first spring portions 64 has one end coupled with the first circular portion 61 in the vicinity of the through-hole 66 of the first circular portion 61 through an outer connecting portion 642, the arch-shaped portion 641 extending along with an inner periphery of the first circular portion 61 and an outer periphery of the second circular portion 62 in the counterclockwise direction, and another end coupled with the second circular portion 62 in the vicinity of the through-hole 67 through an inner connecting portion 643.

The six first spring portions 64 in each of the leaf springs 60U, 60L couple the second circular portion 62 with the first circular portion 61 so that the second circular portion 62 can be vibrated relative to the first circular portion 61 in the vertical direction in FIG. 3. As mentioned above, each of the first circular portions 61 is fixedly held by the housing 20. Further, each of the second circular portions 62 is coupled with the coil holding portion 50. Therefore, when the external vibration of the vibrating body is transmitted to the housing 20, the vibration is transmitted to the second circular portion 62 through the first spring portions 64. As a result, the coil holding portion 50 can be vibrated relative to the housing 20 in the vertical direction.

Each of the three second spring portions 65 in each of the leaf springs 60U, 60L has an arch-shaped portion (a substantially sigmoidal shape). Each of the second spring portions 65 is arranged in a space between the second circular portion 62 and the third circular portion 63. In more detail, the second spring portions 65 are arranged so as to be rotational symmetric with each other around the central axis of the third circular portion 63. Each of the second spring portions 65 has one end coupled with the second circular portion 62 in the vicinity of the through-hole 67, the arch-shaped portion extending along with an inner periphery of the second circular portion 62 and an outer periphery of the third circular portion 63 in the clockwise direction, and another end coupled with the third circular portion 63.

The three second spring portions 65 in each of the leaf springs 60U, 60L couple the third circular portion 63 with the second circular portion 62 so that the third circular portion 63 can be vibrated relative to the second circular portion 62 in the vertical direction in FIG. 3. As mentioned above, each of the second circular portions 62 is coupled with the coil holding portion 50. Further, each of the third circular portions 63 of the leaf springs 60U, 60L is directly or indirectly coupled with the magnet assembly 30. Therefore, the vibration which is transmitted from the vibrating body to the second circular portion 62 is transmitted to the third circular portion 63 through the second spring portions 65. As a result, the magnet assembly 30 can be vibrated relative to the coil holding portion 50.

As shown in FIG. 4, each of the leaf springs 60U, 60L explained above has a rotationally symmetrical shape around a central axis thereof (the central axis of the third circular portion 63). This makes it possible to prevent variation in spring constants of the first spring portions 64 and the second spring portions 65 arranged along with the circumferential direction. As a result, it is possible to enhance a lateral stiffness of each of the leaf springs 60U, 60L (stiffness along with a direction orthogonal to the thickness direction of each of the leaf springs 60U, 60L) as a whole. In addition, it is possible to make an assembly work of the power generator 100 (the main unit 1) easier.

The power generator 100 having the above structure includes a first vibrating system in which the coil holding portion 50 coupled with the housing 20 through the first spring portions 64 of the leaf springs 60U, 60L is vibrated relative to the housing 20 and a second vibrating system in which the magnet assembly 30 coupled with the coil holding portion 50 through the second spring portions 65 of the leaf springs 60U, 60L is vibrated relative to the coil holding portion 50. In other words, in the power generator 100, the power generating unit 10 includes a two degrees of freedom vibrating system having the first vibrating system and the second vibrating system.

In the power generating unit 10 having such two degrees of freedom vibrating system, the first vibrating system has a first natural frequency ω₁ determined by a mass m₁ of the coil holding portion 50 holding the coil 40 (hereinafter, the coil holding portion 50 holding the coil 40 is sometimes referred to as the coil holding portion 50 simply), amass ratio μ between the coil holding portion 50 and the magnet assembly 30 and a spring constant ω₁ of the first spring portions 64. On the other hand, the second vibrating system has a second natural frequency ω₂ determined by a mass m₂ of the magnet assembly 30, the mass ratio μ between the coil holding portion 50 and the magnet assembly 30 and a spring constant k₂ of the second spring portions 65. The natural frequencies ω₁ and ω₂ can be expressed by the following motion equation (1) according to the model diagram for the two degrees of freedom vibrating system.

$$\begin{matrix}[ Motion equation ( 1 ) ] & \\ [ \begin{matrix}{ω}_{1} \\ {ω}_{2}\end{matrix} ] = \frac{1}{2} \{ {Ω}_{1}^{2} + ( 1 + μ ) {Ω}_{2}^{2} \} ∓ \sqrt{{( {Ω}_{1}^{2} + ( 1 + μ ) {Ω}_{2}^{2} \}}^{2} - 4 {Ω}_{1}^{2} {Ω}_{2}^{2}} & ( 1 )\end{matrix}$$

wherein “μ” is defined by

$$\frac{{m}_{2}}{{m}_{1}} ,$$

“Ω₁” is defined by

$$\sqrt{\frac{{k}_{1}}{{m}_{1}}}$$

and “Ω₂” is defined by

$$\sqrt{\frac{{k}_{2}}{{m}_{2}}}$$

Namely, each of the natural frequencies ω₁ and ω₂ is determined by the above three parameters of “μ”, “Ω₁” and “Ω₂”.

The amount of electric power generated by the two degrees of freedom vibrating system (power generating capacity of the two degrees of freedom vibrating system) represented by the motion equation (1) decays due to power generation. The amount of the generated electric power maximizes at two resonant frequencies f₁ and f₂ respectively determined by the two natural frequencies ω₁ and ω₂. Namely, in the power generator 100, the power generating unit 10 can be efficiently vibrated relative to the housing 20 in a broad frequency range between the two resonant frequencies f₁ and f₂. In a case where the two degrees of freedom vibrating system has no decay, the natural frequencies ω₁ and ω₂ are respectively equal to the resonant frequencies f₁ and f₂.

By setting the masses (m₁ and m₂) and the spring constants (k₁ and k₂) of the vibrating systems so that the first resonant frequency f₁ is different from the second resonant frequency f₂, that is, reduplication of the resonant frequency is achieved, the generating unit 10 can be efficiently vibrated by the external vibration (that is, vibration applied to the housing 20) having a frequency other than the set resonant frequencies f₁ and f₂.

For example, in a case where the frequency of the vibrating body is in the range of 20 to 40 Hz, it is preferred that the masses (m₁ and m₂) and the spring constants (k₁ and k₂) of the vibrating system are adjusted so as to satisfy the following conditions represented by the following conditional equations (1A) to (3A). This makes it possible to especially improve power generation efficiency of the power generator 100 with the external vibration of the vibrating body having the above frequency.

m₁[kg]:m₂[kg]=1.5:1 (1A)

m₁[kg]:k₁[N/m]=1:60000 (2A)

m₂[kg]:k₂[N/m]=1:22000 (3A)

In order to set the spring constants (k₁ and k₂) of the spring portions (the first spring portions 64 and the second spring portions 65) at desired values, an average thickness of each of the leaf springs 60U, 60L may be appropriately adjusted. In this time, the average thickness of each of the leaf springs 60U, 60L is preferably in the range of about 0.1 to 0.4 mm, and more preferably in the range of about 0.2 to 0.3 mm. By setting the average thickness of each of the leaf springs 60U, 60L to be within the above range, it is possible to reliably prevent plastic deformations, fractures and the like of the leaf springs 60U, 60L. This makes it possible to use the power generator 100 over a long time in a state that the power generator 100 is fixedly attached to the vibrating body.

<<Magnet Assembly 30>>

The magnet assembly 30 having the permanent magnet 31 is supported between the upper leaf spring 60U and the lower leaf spring 60L.

The magnet assembly 30 includes the permanent magnet 31 having a cylindrical shape, a back yoke 32 formed by a bottom plate having a central portion on which the permanent magnet 31 is provided and a periphery, and a circular yoke 33 disposed on an upper side of the permanent magnet 31. The magnet assembly 30 is supported between the leaf springs 60U, 60L in a state that the periphery of the bottom plate is coupled with the third circular portion 63 of the lower leaf spring 60L and the yoke 33 is coupled with the third circular portion 63 of the upper leaf spring 60U through the spacer 70.

The permanent magnet 31 is disposed between the back yoke 32 and the yoke 33 so that a north pole of the permanent magnet 31 faces to the yoke 33 and a south pole of the permanent magnet 31 faces to the bottom plate 321 of the back yoke 32. Namely, the magnet assembly 30 is supported between the leaf springs 60U, 60L so that the magnet assembly 30 can be displaced in a magnetization direction.

Examples of the permanent magnet 31 include an alnico magnet, a ferrite magnet, a neodymium magnet, a samarium-cobalt magnet, a bonded magnet obtained by molding a compound material constituted of pulverized materials of the above magnets which are mixed with a resin material or a rubber material. The permanent magnet 31 is fixedly supported between the back yoke 32 and the yoke 33, for example, by own magnetic force (attraction force) or an adhesive agent.

The yoke 33 has a size in the planer view substantially equal to a size of the permanent magnet 31 in the planar view. The yoke 33 has a threaded hole 331 formed in a central portion thereof.

The back yoke 32 has the bottom plate 321 and a cylindrical portion 322 upwardly extending from the periphery of the bottom plate 321. The permanent magnet 31 is disposed on the central portion of the bottom plate 321 concentrically with the cylindrical portion 332. The threaded hole 331 is formed in the central portion of the permanent magnet 31. The magnet assembly 30 having such back yoke 32 can increase a magnetic flux generated from the permanent magnet 31.

Examples of constituent materials for the back yoke 32 and the yoke 33 include a pure iron (for example, JIS SUY), a soft iron, a carbon iron, a magnetic steel (a silicon steel), a high-speed tool steel, a structural steel (for example, JI SS400), a stainless, a permalloy and a combination of two or more of the above materials.

<<Coil Holding Portion 50>>

The coil holding portion 50 is disposed between the magnet assembly 30 and the housing 20. The coil holding portion 50 includes a main body 51 and a ring-shaped member 52 having an opening formed at a central portion of the ring-shaped member 52. The main body 51 has a cylindrical shape having a peripheral portion.

The cylindrical shape of the main body 51 resembles a shape formed by lightening a peripheral portion of a cylindrical block. The six boss sections 511 are formed in the peripheral portion of the main body 51 along with a circumferential direction of the main body 51 so as to extend in the vertical direction. The upper threaded holes 511a are respectively formed on the upper ends of the boss sections 511. The lower threaded holes 511b are respectively formed on the lower ends of the boss sections 511.

The opening of the ring-shaped member 52 is integrally formed with the main body 51. The ring-shaped member 52 has an inner diameter larger than an outer diameter of the spacer 70 (the main body 71). The coil 40 is supported on the lower surface of the ring-shaped member 52 of the coil holding portion 50 and positioned close to an inner periphery of the opening of ring-shaped member 52.

<<Coil 40>>

The coil 40 has an outer diameter smaller than that of the cylindrical portion 322 of the back yoke 32 and an inner diameter larger than those of the permanent magnet 31 and the yoke 33. This makes it possible to dispose the coil 40 between the cylindrical portion 322 of the back yoke 32 and the permanent magnet 31 of the magnet assembly 30 without contacting with the cylindrical portion 322 and the permanent magnet 31 in the assembled state.

The coil 40 can be displaced relative to the permanent magnet 31 in the vertical direction due to the vibration of the power generating unit 10. In this time, a magnetic flux density passing through the coil 40 caused by the permanent magnet 31 changes, and thus electric voltage is generated (induced) in the coil 40.

The coil 40 is formed by winding a wire rod. The wire rod is not limited to a specific type, but examples of the wire rod include a wire rod obtained by covering a copper base line with an insulating film, a wire rod obtained by covering a copper base line with an insulating film having adhesiveness and a combination thereof. The number of turns in the coil 40 is not limited to a specific number and may be appropriately set according to a cross-sectional area of the wire rod and the like. A cross-sectional shape of the wire rod may be any shape such as a polygonal shape including a triangular shape, a square shape, a rectangle shape and a hexagonal shape, a circular shape and an elliptical shape.

Both ends of the wire rod forming the coil 40 are connected with the connector 11 through an electric voltage output unit (not shown) disposed above the ring-shaped member 52 of the coil holding portion 50. This makes it possible to output the electric voltage generated in the coil from the connector 11.

The magnet assembly 30 is coupled with the upper leaf spring 60U through the spacer 70.

<<Spacer 70>>

The spacer 70 has a main body 71 having a cylindrical shape with a sealed end and a non-sealed end, and a circular flange 72 integrally formed along with an outer periphery of the non-sealed end. The sealed end of the spacer 70 is coupled with the magnet assembly 30 (the yoke 33) by the screw 73. An outer side of an upper surface of the flange 72 is coupled with the third circular portion 63 of the upper leaf spring 60U.

Examples of a constituent material for the spacer 70 include magnesium, aluminum and a resin material for molding.

As shown in FIG. 3, in the power generator 100 having such structure, when the external vibration of the vibrating body is transmitted to the housing 20, the power generating unit 10 is vibrated in the housing 20 in the vertical direction. In more detail, the coil holding portion 50 coupled with the housing 20 through the first spring portions 64 of the leaf springs 60U, 60L is vibrated relative to the housing 20 (namely, the first vibrating system is vibrated). In the same manner, the magnet assembly 30 coupled with the coil holding portion 50 through the second spring portions 65 of the leaf springs 60U, 60L is vibrated relative to the coil holding portion 50 holding the coil 40 (namely, the second vibrating system is vibrated).

Each of the leaf springs 60U, 60L has a lateral spring constant in a lateral direction perpendicular to the vibrating direction of the spring portions 64, 65 (the vertical direction). The lateral spring constant is structurally larger than the spring constant in the vibrating direction of the spring portions 64, 65. Namely, each of the leaf springs 60U, 60L has a longitudinal stiffness in a thickness direction thereof and a lateral stiffness in the lateral direction larger than the longitudinal stiffness. Thus, each of the leaf springs 60U, 60L is more likely to be distorted or deformed in the thickness direction than the lateral direction. Further, both ends in the thickness direction of each of the magnet assembly 30 and the coil holding portion 50 are coupled with the leaf springs 60U, 60L. Thus, the magnet assembly 30 and the coil holding portion 50 can be vibrated together with the leaf springs 60U, 60L.

For the reasons explained above, it is possible to prevent the magnet assembly 30 and the coil holding portion 50 from being vibrated in the lateral direction perpendicular to the thickness direction of the leaf springs 60U, 60L (lateral motion) and being rotated (rolling motion). This makes it possible to restrict a vibrational axis of the magnet assembly 30 and the coil holding portion 50 to a specific direction (the vertical direction). Further, as explained above, the coil 40 is disposed so as not to contact with the magnet assembly 30 (the permanent magnet 31, the yoke 33 and the back yoke 32).

As a result, it is possible to prevent the magnet assembly 30 and the coil holding portion 50 from contacting with each other while the power generating unit 10 is vibrated (that is, at the time of generating electric power). In particular, since both the magnet assembly 30 and the coil holding portion 50 have high stiffness, both the magnet assembly 30 and the coil holding portion 50 also have a high lateral stiffness in the lateral direction perpendicular to the vibrating direction as well as the leaf springs 60U, 60L. Thus, it is possible to reliably prevent the magnet assembly 30 and the coil holding portion 50 from contacting with each other.

As explained above, in the power generator 100, since the contact between the magnet assembly 30 and the coil holding portion 50 is avoided, it is possible to efficiently transmit vibrational energy of the vibrating body to the first vibrating system and then efficiently transmit vibrational energy of the first vibrating system to the second vibrating system. As a result, a relative displacement between the magnet assembly 30 and the coil 40 is reliably performed. As shown in FIG. 3, a magnetic loop (magnetic circuit) generated by the permanent magnet 31, the yoke 33 and the back yoke 32 flows from a center to a periphery of the magnet assembly 30 through the yoke 33 and flows from the periphery to the center of the magnet assembly 30 through the back yoke 32.

In such structure, a magnetic field having a magnetic flux density B (the magnetic loop) generated from the permanent magnet 31 is varied in the coil 40 due to the relative displacement between the magnet assembly 30 and the coil 40. This variation of such magnetic flux density B induces an electromotive force in the coil 40 due to Lorentz force acting on electrons in the coil 40 through which the magnetic field passes. The electromotive force directly contributes to the power generation of the power generating unit 10. Thus, the power generating unit 10 can efficiently generate electric power.

The main unit 1 having such structure further has the attachment provided (mounted) on the lower surface (a surface opposed to the power generating unit 10) 230 of the base (support board) 23. The attachment has a function of fixedly attaching the main unit 1 to the vibrating body. Examples of a method for fixedly attaching the main unit 1 to the vibrating body with the attachment include a bonding method by an adhesive agent or an adhesive tape, a magnetically attaching by a permanent magnet, a mechanical attaching by a screw and a combination of two or more of the above methods.

If each of the resonant frequencies f₁ and f₂ of the power generator 100 changes from a predetermined (desired) frequency, the power generating capacity of the power generator 100 reduces. As explained above, the power generating unit 10 includes the two degrees of freedom vibrating system. Each of the resonant frequencies f₁ and f₂ of the first and the second vibrating systems is determined by the spring constants (k₁, k₂) and the masses (m₁, m₂) of the vibrating systems. Thus, when each of the resonant frequencies f₁ and f₂ changes from the predetermined frequency by just several percent, a frequency sensitivity of the power generating unit 10 (power generator 100) with respect to the frequency of the external vibration drastically changes as shown in FIG. 5. Therefore, it is necessary to precisely correct the frequency sensitivity of the power generator 100 by precisely readjusting the resonant frequencies f₁ and f₂.

It is possible to adjust the resonant frequencies f₁ and f₂ of the vibrating systems in the power generator 100 by adjusting (changing) at least one of the spring constants of the first spring portions 64 and the spring constants of the second spring portions 65. Thus, the power generator 100 of the present invention further has at least one of a first spring constant adjuster 12 for adjusting the spring constants of the first spring portions 64 and a second spring constant adjuster 13 for adjusting the spring constants of the second spring portions 65. In this embodiment, the power generator 100 has only the first spring constant adjuster 12.

<<First Spring Constant Adjuster 12>>

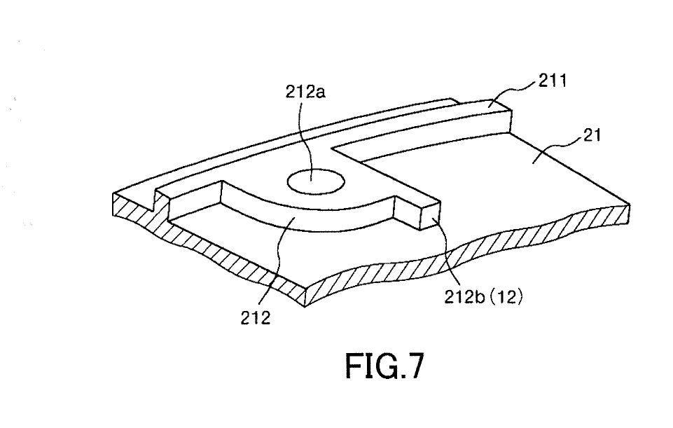

The first spring constant adjuster 12 has clipping members for clipping the connecting portions 642 of the first spring portions 64 (peripheral portions of the first circular portions). As shown in FIGS. 6 and 7, each of the clipping members includes a middle protrusion (protruded line) 221c formed on a peripheral portion of each of the boss sections 221 of the cylindrical portion 22 so as to extend along with the height direction of the cylindrical portion 22 (the vertical direction), an upper protrusion 212b formed on a peripheral portion of each of the boss sections 212 of the cover 21 so as to extend along with the thickness direction of the cover 21 (the vertical direction) and a lower protrusion (not shown) formed on a peripheral portion of each of the boss sections 232 of the base 23 so as to extend along with the thickness direction of the base 23 (the vertical direction).

As shown in FIGS. 6 and 7, each of the protrusions (each of clipping members) are integrally formed with each of the corresponding boss sections (housing 20). Each of an overall profile of the upper protrusion 212b and the boss section 212, an overall profile of the middle protrusion 221c and the boss section 221 and an overall profile of the lower protrusion and the boss section 232 are identical to each other in a planar view. As shown in FIG. 8, when the upper leaf spring 60U is held between the cover 21 and the cylindrical portion 22, the connecting portions 642 of the first spring portions 64 of the upper leaf spring 60U are respectively clipped between the upper protrusions 212b of the cover 21 and the middle protrusions 221c of the cylindrical portion 22. In the same manner, when the lower leaf spring 60L is held between the cylindrical portion 22 and the base 23, the connecting portions 642 of the first spring portions 64 of the lower leaf spring 60L are respectively clipped between the middle protrusions 221c of the cylindrical portion 22 and the lower protrusions of the base 23.

When the power generating unit 10 is vibrated, stress occurs in each of the first spring portions 64 of the upper leaf spring 60U as shown in FIG. 9 under the influence of clipped portions between the upper protrusions 212b of the cover 21 and the middle protrusions 221c of the cylindrical portion 22. In particular, as shown in FIG. 9b, the stress maximizes in connecting areas in which the arch-shaped portions 641 are respectively coupled with and the connecting portions 642 (areas shown by dark gray color in FIG. 9). The stress in each of the first spring portions 64 decreases with a distance from each of the connecting areas. Therefore, if the clipped portions in the connecting areas between the connecting portions 642 and the arch-shaped portions 641 and the vicinities thereof (that is, areas mainly contribute to the spring constants of the first spring portions 64) are slid (moved) from initial positions, the stress distribution in the first spring portions 64 is varied. Thus, it is possible to adjust the spring constants of the first spring portions 64 by sliding (relocating) the clipped portions. This discussion can be applied to the lower leaf spring 60L.

In more detail, an initial state shown in FIG. 8 can be changed to another state shown in FIG. 10a by rotating the pair of leaf springs 60U, 60L around the central axis of the third circular portions 63 (housing 20) relative to the housing 20 together with the magnet assembly 30 and the coil holding portion 50 (namely, the power generating unit 10) coupled with the pair of leaf springs 60U, 60L in a lower direction (counterclockwise direction) in FIG. 8. As a result, the clipped portions clipped by the clipping members are slid in a direction away from each of the connecting areas between the connecting portions 642 and the arch-shaped portions 641 as shown in FIG. 10a. Namely, the clipped portions clipped by the clipping members can be slid by rotating the pair of leaf springs 60U, 60L relative to the housing 20 around the central axis of the third circular portions 63 (housing 20). This makes it possible to decrease the spring constants of the first spring portions 64 compared with the initial state shown in FIG. 8.

On the other hand, the initial state shown in FIG. 8 can be changed to another state shown in FIG. 10b by rotating the pair of leaf springs 60U, 60L around the central axis of the third circular portions 63 relative to the housing 20 in an upper direction (clockwise direction) in FIG. 8. As a result, the clipped portions clipped by the clipping members are slid into the connecting areas between the connecting portions 642 and the arch-shaped portions 641 as shown in FIG. 10b. This makes it possible to increase the spring constants of the first spring portions 64 compared with the initial state shown in FIG. 8. In these ways, it is possible to adjust the spring constants of the first spring portions 64.

In this embodiment, the middle protrusions 221c are respectively provided on the peripheral portions of the three boss sections 221 arranged so as to be rotationally symmetric with each other around the central axis of the cylindrical portion 22 (third circular portions 63). The upper protrusions 212b and the lower protrusions of the base 23 are respectively formed on the peripheral portions of the boss sections 212 and the peripheral portions of the boss sections 232, which respectively correspond to the boss sections 221 of the cylindrical portion 22. In other words, the first spring constant adjuster (clipping members) 12 is provided so as to correspond to the three first spring portions 64 arranged to be rotationally symmetric with each other around the central axis of the third circular portions 63. Thus, it is possible to adjust the spring constants of the three first spring portions 64 all together by rotating the pair of leaf springs 60U, 60L (power generating unit 10) relative to the housing 20. This makes it possible to prevent the spring constants of the first spring portions 64 from unevenly varying (that is, the spring constants of the first spring portions 64 can remain good balance being rotationally symmetric) after the spring constants of the three first spring portions 64 are adjusted.

The first spring constant adjuster (clipping members) 12 may be provided so as to correspond to the two first spring portions 64 symmetrically arranged with each other or the six first spring portions 64.

If a power generator has no first spring constant adjuster (clipping members) 12 having such structure, it is required that the plurality of first spring portions 64 are respectively adjusted so that the spring constants of the first spring portions 64 are identical to each other and balance among the spring constants of the first spring portions 64 is kept in such power generator. However, it is impossible to determine whether or not the balance among the spring constants of the first spring portions 64 is kept (changed) from the resonant frequencies (resonant points) of the power generator which can be measured. Thus, in order to detect the change of the balance among the spring constants of the first spring portions 64, it is required to measure displacements of the power generating unit 10 in some directions and the like by some measuring methods and then analyze those measurement results by an advance modal analyzing device and the like. Therefore, in the power generator having no first spring constant adjuster 12, such advanced measurement device is required for adjusting the spring constants of the first spring portions 64. As a result, processes for adjusting the spring constants of the first spring portions 64 increase.

In contrast, since the power generator 100 of the present invention has the first spring constant adjuster 12, it is possible to adjust the spring constants of the first spring portions 64 all together (by one operation) so that the balance among the spring constants of the first spring portions 64 is kept.

Guide pins 222 respectively having a distal end 222a are integrally formed with the cylindrical portion 22 in the vicinities of the three boss sections on which the middle protrusions 221c are formed. On the other hand, through-holes are respectively formed in the vicinities of the through-holes 66 of the leaf springs 60U, 60L as shown in FIGS. 4 and 8. The distal ends 222a of the guide pins 222 respectively pass through the through-holes 68. Each of the through-holes is an elliptic hole (slot) extending along with the circumferential direction of the first circular portions 61.

In the assembled state, the distal ends 222a of the guide pins 222 respectively pass through the through-holes 68. Thus, the leaf springs 60U, 60L can be slid relative to the housing 20 in the circumferential direction of the first circular portions 61 (in the vertical direction in FIG. 8) with being guided by the through-holes 68 and the guide pins 222 when the power generating unit 10 is rotated relative to the housing 20. This makes it possible to prevent the power generating unit from rotating (sliding) toward an unwanted direction, thereby it is possible to smoothly rotate the power generating unit 10 relative to the housing 20 in a predetermined direction.

The power generator 100 has a manipulating mechanism 19 for rotating the pair of leaf springs 60U, 60L (power generating unit 10) relative to the housing 20.

<<Manipulating Mechanism 19>>

As shown in FIGS. 11 to 13, manipulating boss sections 223 are integrally formed with the cylindrical portion 22 of the housing 20 at predetermined positions in the vicinities of the guide pins 222. Further, concave portions 223a are respectively formed on upper ends of the manipulating boss sections 223 into which a manipulating pin 402 is inserted. Each of the concave portions 223a has an elliptic shape (elliptic aperture) extending along with the circumferential direction of the cylindrical portion 22 in a planar view.

Through-holes 69 are formed in the first circular portion 61 of the upper leaf spring 60U so as to respectively correspond to the concave portions 223a of the manipulating boss sections 223. Each of the through-holes 69 has an elliptic shape extending along with a direction perpendicular to the concave portions 223a in a planar view (radial direction of the upper leaf spring 60U). Thus, in the assembled state, a part of each of the concave portions 223a is not covered by the first circular portion 61 of the upper leaf spring 60U as shown in FIG. 11. Namely, the part of each of the concave portions 223a is exposed through each of the through-holes 69. Thus, it is possible to insert the manipulating pin 402 into one of the concave portions 223a through one of the exposed parts of the concave portions 223a.

As shown in FIGS. 12 and 13, concave portions 215 are formed on an upper side of the cover 21 so as to respectively correspond to the manipulating boss sections 223. Through-holes 215a are respectively formed in the concave portions 215 of the manipulating boss sections 223 so as to respectively correspond to the concave portions 223a of the manipulating boss sections 223. Each of the through-holes 215a has a shape identical to those of the concave portions 223a in a planar view.

For example, a manipulating tool 400 can be used for manipulation for rotating the power generating unit 10 relative to the housing 20. The manipulating tool 400 has a columnar main body 401 and a manipulating pin (eccentric pin) 402 provided on a distal end of the main body 401 so as not to align a central axis of the manipulating pin 402 with a central axis of the main body 401. The distal end of the main body 401 is inserted into one of the concave portions 215 of the cover and the manipulating pin 402 is inserted into the through-hole 69 corresponding to the one of the concave portions 215.

Next, description will be given to a method for adjusting the spring constants of the first spring portions 64 by using the above manipulating pin 402.

First, the screws 213 respectively screwed into the upper threaded holes 221a passing through the through-holes 66 of the upper leaf spring 60U and the through-holes 212a of the cover 21 are loosened. As a result, the first circular portion 61 of the upper leaf spring 60U is loosely held between the cover 21 and the cylindrical portion 22. Namely, the upper leaf spring 60U is released from the fixing state between the cover 21 and the cylindrical portion 22. In the same manner, the screws 233 respectively screwed into the lower threaded holes 221b passing through the through-holes 232a of the base 23 and the through-holes 66 of the lower leaf spring 60L are loosened. As a result, the first circular portion 61 of the lower leaf spring 60L is loosely held between the cylindrical portion 22 and the base 23. Namely, the lower leaf spring 60L is released from the fixing state between the cylindrical portion 22 and the base 23.

Next, the manipulating pin 402 of the manipulating tool 400 is inserted into one of the concave portions 223a of the cylindrical portion 22 passing through the through-hole 215a of the cover 21 and the through-hole 69 of the upper leaf spring 60U, which correspond to the one of the concave portions 223a, and the distal end of the main body 401 of the manipulating tool 400 is inserted into the concave portion 215 of the cover 21 corresponding to the one of the concave portions 223a. When the main body 401 of the manipulating tool 400 in this state is rotated, the main body 401 is rotated around the central axis thereof in a state that the distal end of the main body 401 is inserted into the one of the concave portions 215 of the cover 21.

On the other hand, since the manipulating pin 402 is provided on the distal end of the main body 401 so as not to align the central axis of the manipulating pin 402 with the central axis of the main body 401, the manipulating pin 402 is slid along with the through-hole 215a of the cover 21 and the concave portions 223a of the cylindrical portion 22 in which the manipulating pin 402 passes through. In this time, the manipulating pin 402 contacts with a longitudinal boundary (peripheral) of the through-hole 69 of the upper leaf spring 60U. By sliding the manipulating pin 402, the upper leaf spring 60U (whole of the power generating unit 10) is rotated relative to the housing 20.

By such manipulations, the connecting areas between the connecting portions 642 and the arch-shaped portions 641 (that is, areas in which the maximum stresses occur) are clipped by the clipping members (first spring constant adjuster 12) as shown in FIG. 10b. In this situation, the spring constants of the first spring portions 64 increase, thereby it is possible to increase the resonant frequency of the power generating unit 10 (power generator 100). On the other hand, by other manipulations, areas relatively away from the connecting areas between the connecting portions 642 and the arch-shaped portions 641 (that is, areas in which relative weak stresses occur) are clipped by the clipping members (first spring constant adjuster 12) as shown in FIG. 10a. In this situation, the spring constants of the first spring portions 64 decrease, thereby it is possible to decrease the resonant frequency of the power generating unit 10 (power generator 100).

Therefore, it is possible to desirably adjust the spring constants of the first spring portions 64 by rotating the power generating unit 10 relative to the housing 20 so that the clipping members respectively clip the first circular portion 61 of the upper leaf spring 60U at desired clipped positions between clipping positions shown in FIG. 10a and clipping positions shown in FIG. 10b.

### Second Embodiment

Next, description will be given to a power generator 100 according to the second embodiment.

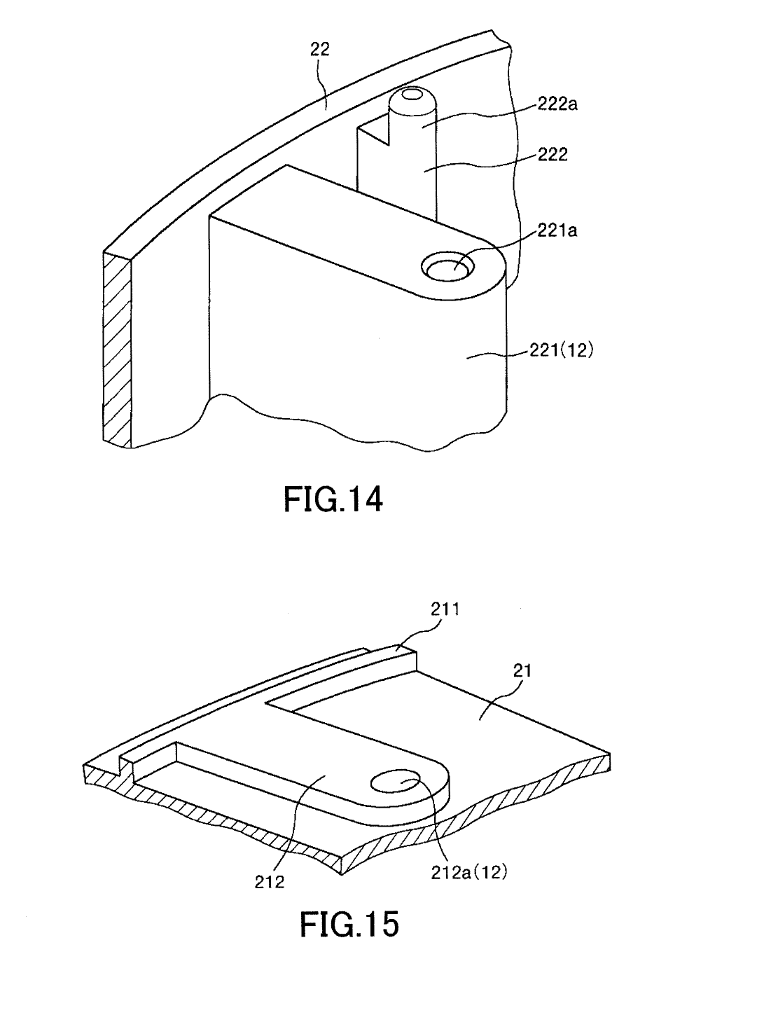

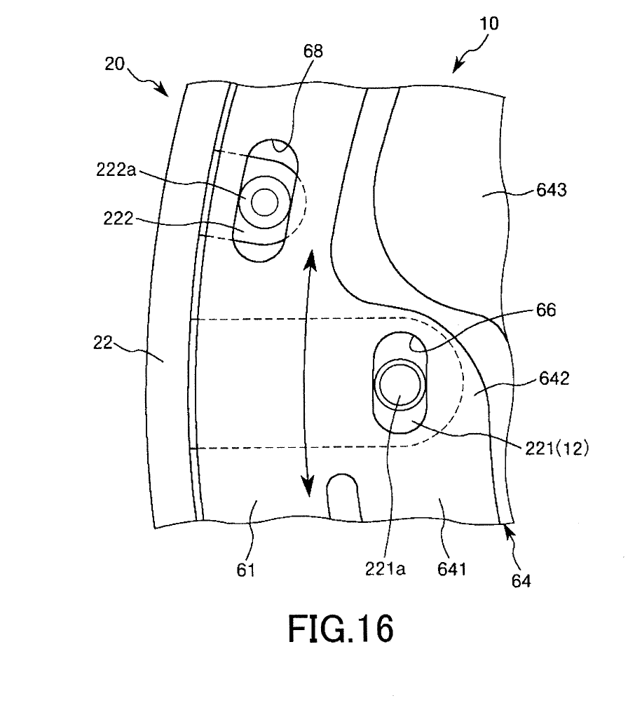

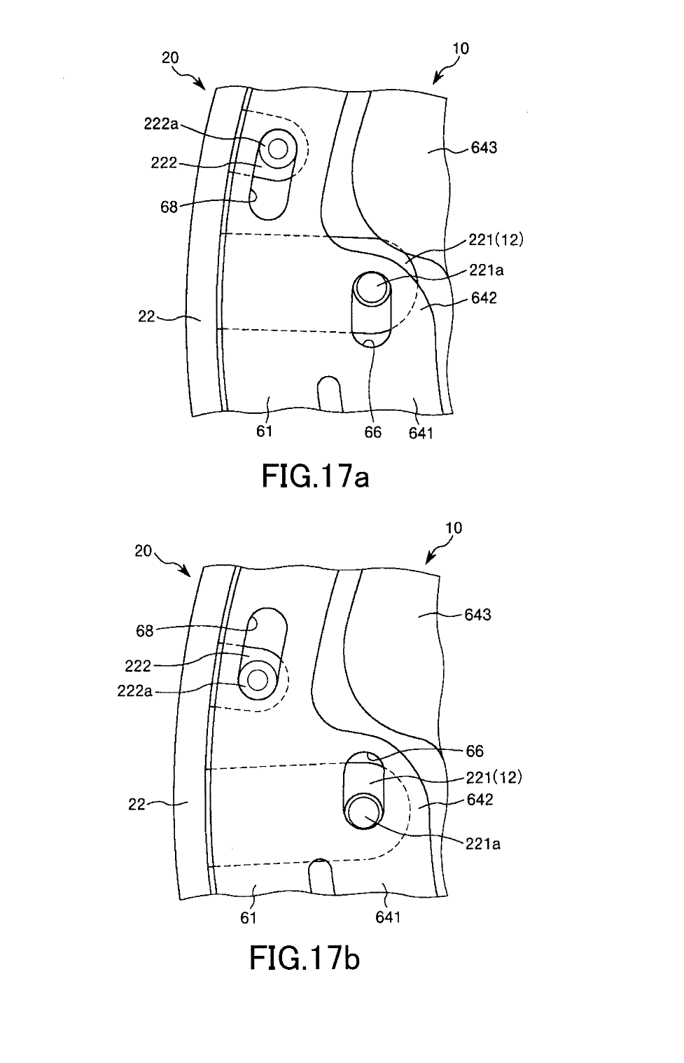

Each of FIGS. 14 to 16 is a perspective view showing a first spring constant adjuster 12 according to the second embodiment of the present invention. FIG. 17 is a planar view for explaining an action of the first spring constant adjuster 12 according to the second embodiment of the present invention. Hereinafter, an upper side in FIG. 14 is referred to as “upper” or “upper side” and a lower side in FIG. 14 is referred to as “lower” or “lower side”. Further, an upper side in FIG. 15 is referred to as “lower” or “lower side” and a lower side in FIG. 15 is referred to as “upper” or “upper side”. Furthermore, a front side of the paper in each of FIGS. 16 and 17 is referred to as “upper” or “upper side” and a rear side of the paper in each of FIGS. 16 and 17 is referred to as “lower” or “lower side”.

Hereinafter, the power generator 100 according to the second embodiment will be described by placing emphasis on the points differing from the power generator 100 according to the first embodiment, with the same matters omitted from description. The power generator 100 according to the second embodiment has the same structure as the first embodiment except that the structure of the first spring constant adjuster 12 is modified.

As shown in FIG. 14, the first spring constant adjuster 12 according to the second embodiment has middle boss sections 221 formed on the inner circumferential surface of the cylindrical portion 22 so as to extend toward the central axis of the cylindrical portion 22, upper boss sections 212 formed on an inner side of the cover 21 so as to extend toward a central axis of the cover 21 as shown in FIG. 15 and lower boss sections 232 (not shown) formed on an inner side of the base 23.

As shown in FIG. 16, in the leaf springs 60U, 60L, through-holes 66 are respectively formed in the connecting portions 642 of the six first spring portions 64 so as to correspond to the middle boss sections 221. Each of the through-holes 66 is an elliptic hole (slot) extending along with the circumferential direction of the first circular portion 61 as the same of the first embodiment.

As shown in FIG. 16, the connecting portions 642 of the first spring portions 64 of the upper leaf spring 60U are respectively clipped between the upper boss sections 212 of the cover 21 and the middle boss sections 221 of the cylindrical portion 22 when the upper leaf spring 60U is fixedly held between the cover 21 and the cylindrical portion 22. On the other hand, the connecting portions 642 of the first spring portions 64 of the lower leaf spring 60L are respectively clipped between the middle boss sections 221 and the lower boss sections 232 of the base 23 when the lower leaf spring 60L is fixedly held between the cylindrical portion 22 and the base 23.

An initial state shown in FIG. 16 can be changed to another state by rotating the power generating unit 10 in a lower direction in FIG. 16 (in a counterclockwise direction in FIG. 16) around the central axis of the third circular portions 63 (housing 20) relative to the housing 20. As a result, the clipped portions clipped by the boss sections 221, 212 and 232 are slid in a direction away from each of the connecting areas between the connecting portions 642 and the arch-shaped portions 641 as shown in FIG. 17a. This makes it possible to decrease the spring constants of the first spring portions 64 compared with the initial state shown in FIG. 16 because substantive lengths of the first spring portions 64 acting as springs become longer.

On the other hand, the initial state shown in FIG. 16 can be changed to another state by rotating the pair of leaf springs 60U, 60L around the central axis of the housing 20 relative to the housing 20 in an upper direction (clockwise direction) in FIG. 16. As a result, the clipped portions clipped by the clipping members are slid into the connecting areas between the connecting portions 642 and the arch-shaped portions 641 as shown in FIG. 17b. This makes it possible to increase the spring constants of the first spring portions 64 compared with the initial state shown in FIG. 16 because substantive lengths of the first spring portions 64 acting as springs become shorter. In these ways, it is possible to adjust the spring constants of the first spring portions 64.

The power generator 100 having the first spring constant adjuster 12 according to the second embodiment can also provide the same effect as the power generators 100 of the first embodiment.

### Third Embodiment

Next, description will be given to a power generator 100 according to the third embodiment.

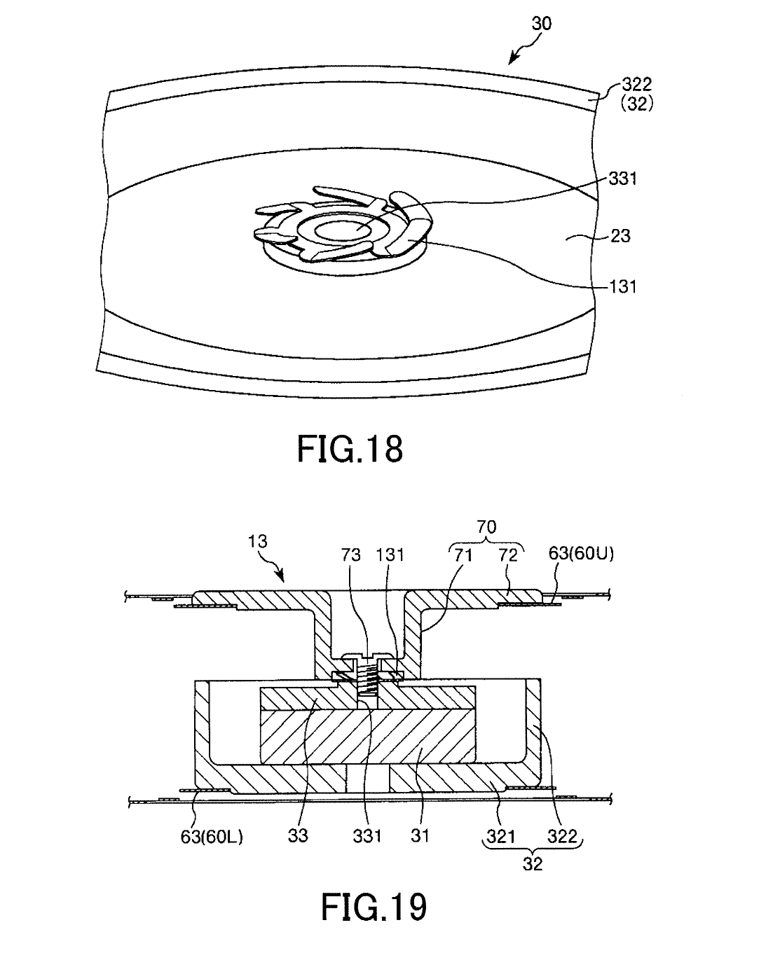

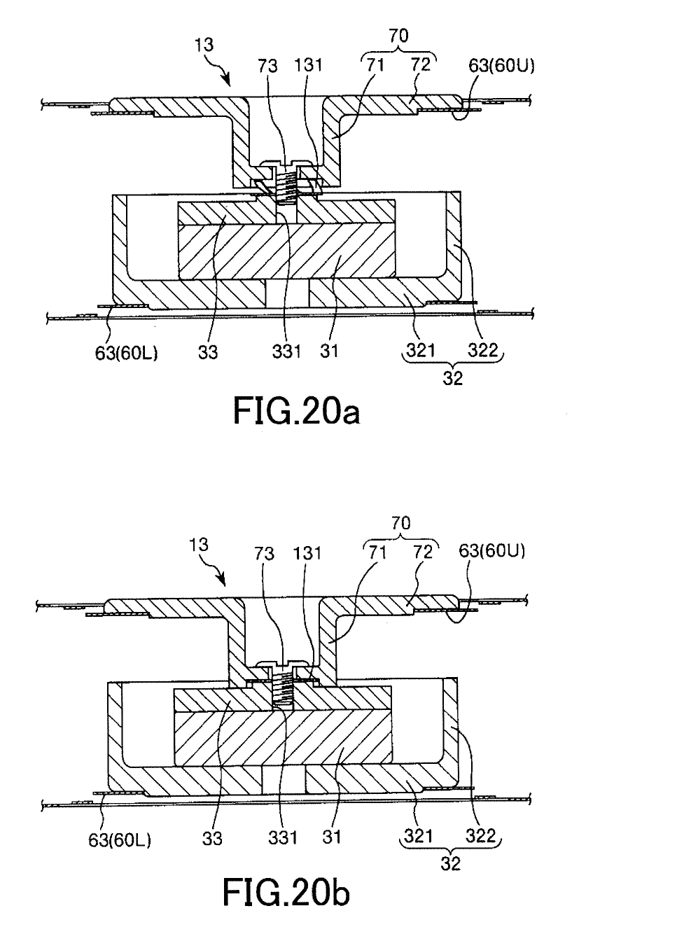

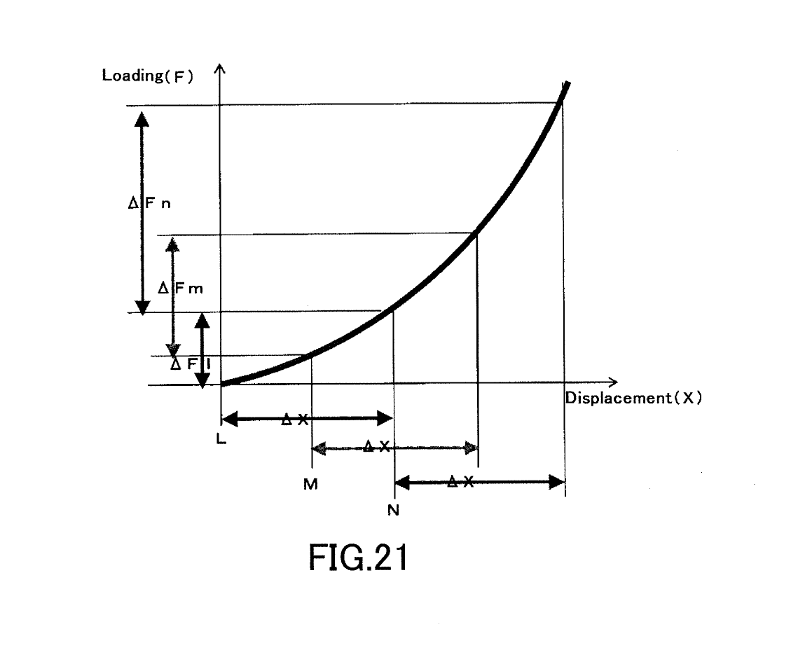

FIG. 18 is a perspective view showing a structure of the second spring constant adjuster 13. FIG. 19 is a longitudinal cross-sectional view showing a structure of the second spring constant adjuster 13. FIG. 20 is a longitudinal cross-sectional view for explaining an action of the second spring constant adjuster 13. FIG. 21 is a graph for explaining change of the spring constants of the second spring portions 65. Hereinafter, an upper side in each of FIGS. 18 to 20 is referred to as “upper” or “upper side” and a lower side in each of FIGS. 18 to 20 is referred to as “lower” or “lower side”.

Hereinafter, the power generator 100 according to the third embodiment will be described by placing emphasis on the points differing from the power generators 100 according to the first and the second embodiments, with the same matters omitted from description. The power generator 100 according to the third embodiment has the same structure as the first and the second embodiments except that the power generator 100 has the second spring constant adjuster 13 for adjusting the spring constants of the second spring portions 65 in addition to the first spring constant adjuster 12.

As shown in FIGS. 18 and 19, the second spring constant adjuster 13 has a clearance adjuster for adjusting a clearance between the third circular portions 63 of the pair of leaf springs 60U, 60L. The clearance adjuster according to this embodiment has the spacer 70, the screw (clearance adjusting member) 73 passing through the spacer 70, the threaded hole (female screw) 331 into which the screw 73 is screwed and a spring washer (elastic body) 131 disposed between the spacer 70 and the yoke 33.

Both the spacer 70 and the magnet assembly 30 are biased in a direction away from each other by the spring washer 131. Thus, an initial state shown in FIG. 19 can be changed to another state shown in FIG. 20a by loosening the screw 73. In this state, a clearance between the spacer 70 and the magnet assembly 30 becomes larger. Thus, the clearance between the third circular portions 63 of the pair of leaf springs 60U, 60L also becomes larger because the third circular portion 63 of the upper leaf spring 60U is coupled with the spacer 70 and the third circular portion 63 of the lower leaf spring 60L is coupled with the magnet assembly 30.

On the other hand, the initial state shown in FIG. 19 can be changed to another state shown in FIG. 20b by further screwing the screw 73 into the threaded hole 331. In this state, the clearance between the spacer 70 and the magnet assembly 30 becomes smaller against bias force of the spring washer 131. Thus, the clearance between the third circular portions 63 of the pair of leaf springs 60U, 60L also becomes smaller.

It is possible to respectively add pre-tensions to the second spring portions 65 of the leaf springs 60U, 60L by making the clearance between the third circular portions 63 of the pair of leaf springs 60U, 60L smaller. Therefore, it is possible to vary the pre-tensions respectively added to the second spring portions 65 of the leaf springs 60U, 60L by adjusting the clearance between the third circular portions 63 of the pair of leaf springs 60U, 60L with the second spring constant adjuster 13.

As shown in FIG. 21, the spring constants of the second spring portions 65 as well as the spring constants of the first spring portions 64 have characteristics that the spring constants increase along with the amount of displacement X. Thus, in a case where slight pre-tensions are respectively added to the second spring portions 65 as shown in FIG. 19, a starting point of the displacement of each of the second spring portions 65 is shifted to, for example, a point M shown in FIG. 21. As a result, each of the spring constants km of the second spring portions 65 in such state becomes ΔFm/Δx.

On the other hand, in a case where the pre-tensions respectively added to the second spring portions 65 become smaller as shown in FIG. 20a, the starting point of the displacement of each of the second spring portions 65 is shifted to a point L shown in FIG. 21. As a result, each of the spring constants km of the second spring portions 65 in such state becomes ΔFl/Δx smaller than km. In a case where the pre-tensions respectively added to the second spring portions 65 become larger as shown in FIG. 20b, the starting point of the displacement of each of the second spring portions 65 is shifted to a point N shown in FIG. 21. As a result, each of the spring constants km of the second spring portions 65 in such state becomes ΔFn/Δx larger than km.

In these ways, it is possible to adjust the spring constants of the second spring portions 65 by adjusting the clearance between the third circular portions 63 of the leaf springs 60U, 60L and varying the pre-tensions respectively added to the second spring portions 65 of the leaf springs 60U, 60L.

If a power generator has no second spring constant adjuster 13 having such structure, it is required that the plurality of second spring portions 65 are respectively adjusted so that the spring constants of the second spring portions 65 are identical to with each other and balance among the spring constants of the second spring portions 65 is kept in such power generator. However, it is impossible to determine whether or not the balance among the spring constants of the second spring portions 65 is kept (changed) from the resonant frequencies (resonant points) of the power generator which can be measured. Thus, in order to detect the change of the balance among the spring constants of the second spring portions 65, it is required to measure the displacements of the power generating unit 10 in some directions and the like by some measuring methods and then analyze those measurement results by an advance modal analyzing device and the like. Therefore, in the power generator having no second spring constant adjuster 13, such advanced measurement device is required for adjusting the spring constants of the second spring portions 65. As a result, processes for adjusting the constants of the second spring portions 65 increase.

In contrast, since the power generator 100 of the present invention has the second spring constant adjuster 13, it is possible to adjust the spring constants of the second spring portions 65 all together (by one operation) so that the balance of the spring constants of the second spring portions 65 is kept.

As explained above, the pre-tensions are respectively added to the second spring portions 65 in the power generating unit 10. By using such power generating unit 10, postural changes of the power generating unit 10 caused at the time of horizontally or vertically mounting the power generator 100 on the vibrating body are suppressed. Therefore, the power generator 100 can reliably provide high power generation efficiency regardless of the postural of the power generator 100 (regardless of installation locations for the power generator 100).

Further, the second spring constant adjuster 13 according to this embodiment can adjust the spring constants of the second spring portions 65 by decreasing the clearance between the third circular portions 63 of the pair of leaf springs 60U, 60L compared with the initial state in which the third circular portions 63 of the leaf springs 60U, 60L are arranged so as to be parallel with each other. On the other hand, it is also possible to adjust the spring constants of the second spring portions 65 by increasing the clearance between the third circular portions 63 of the pair of leaf springs 60U, 60L. In this case, however, the height (size in the vertical direction) of the housing 20 becomes larger. This means that by using the second spring constant adjuster 13 which can adjust the spring constants of the second spring portions 65 by decreasing the clearance between the third circular portions 63 of the pair of leaf springs 60U, 60L, it is possible to downsize the height of the power generator 100.

In this embodiment, the power generator 100 has a vibrating system (spring system) having a resonant frequency determined by a spring constant of the elastic body 131 and the mass of the power generator 100. Assuming that the power generator 100 can efficiently generate electric power by utilizing vibration having a vibrational frequency, the resonant frequency of such vibrating system is preferably set to be equal to or more than 5 times the vibrational frequency, more preferably set to be equal to or more than 7.5 times the vibrational frequency, and even more preferably set to be equal to or more than 10 times the vibrational frequency. Namely, it is possible to prevent the vibrating system due to the spring washer 131 from interfering the power generation of the power generator 100 by setting the resonant frequency of the vibrating system to be sufficiently different from the vibrating frequency of the vibration utilized by the power generator 100. The spring constant of the spring washer 131 can be adjusted by appropriately selecting a shape and/or a constituent material of the spring washer 131. The resonant frequency of the vibrating system can be adjusted by setting the spring constant of the spring washer 131 at a desired value.

Examples of the constituent material for the spring washer 131 include a spring steel, a stainless steel, a phosphor bronze and a combination of two or more of the above materials.

A wave washer formed of the same constituent material as the spring washer 131 or an O-ring formed of other elastomer materials (rubber materials) can be used as an alternative to the spring washer 131. In a case where the spring washer 131 or the wave washer is used, it is possible to broaden adjustable ranges of the spring constants adjusted by the second spring constant adjuster 13 compared with a case where an elastic body such as the O-ring formed of the other elastomer material. Further, in the case where the spring washer 131 or the wave washer is used, it is possible to improve durability of the second spring constant adjuster 13 and suppress time deterioration of the second spring constant adjuster 13.

Although the power generators of the present invention have been described with reference to the accompanying drawings, the present invention is not limited thereto. In the power generator, the configuration of each component may possibly be replaced by other arbitrary configurations having equivalent functions. It may also be possible to add other optional components to the present invention.

For example, it may also be possible to combine the configurations according to the first embodiment to the third embodiment of the present invention in an appropriate manner.

What is claimed is:

1. A power generator configured to be used in a state that the power generator is fixedly attached to a vibrating body, the power generator comprising:
a housing;
a magnet disposed in the housing so that the magnet can be displaced in a magnetization direction thereof;
a coil disposed in the housing so as to surround the magnet without contacting with the magnet;
a coil holding portion disposed between the housing and the magnet, the coil holding portion holding the coil so that the coil can be displaced relative to the magnet in the magnetization direction of the magnet;
a pair of leaf springs disposed in the housing so as to be opposed to each other through at least the magnet, the coil and the coil holding portion, each of the leaf springs having a plurality of first spring portions coupling the housing with the coil holding portion and a plurality of second spring portions coupling the coil holding portion with the magnet; and
at least one of a first spring constant adjuster for adjusting spring constants of the first spring portions and a second spring constant adjuster for adjusting spring constants of the second spring portions,
wherein when the power generator is fixedly attached to the vibrating body, the power generator is configured to generate electric power by utilizing vibration of the vibrating body.

2. The power generator claimed in claim 1, wherein each of the leaf springs includes:
a first circular portion;
a second circular portion arranged on the inner side of the first circular portion concentrically with the first circular portion and coupled with the first circular portion through the first spring portions; and
a third circular portion arranged on the inner side of the second circular portion concentrically with the second circular portion and coupled with the second circular portion through the second spring portions, and
wherein the housing holds the first circular portions of the leaf springs, the coil holding portion is supported between the second circular portions of the leaf springs and the magnet is supported between the third circular portions of the leaf springs.

3. The power generator claimed in claim 2, wherein the first spring portions include a plurality of first spring portions arranged so as to be rotationally symmetric around a central axis of the third circular portion, and
wherein the first spring constant adjuster is configured to adjust the spring constants of the symmetrically arranged first spring portions all together.

4. The power generator claimed in claim 3, wherein each of the first spring portions of the leaf springs has one end portion coupled with the first circular portion and another end portion coupled with the second circular portion,
wherein the first spring constant adjuster has clipping members for respectively clipping clipped portions provided around the one end portions of the first spring portions, and
wherein the first spring constant adjuster is configured to adjust the spring constants of the first spring portions by sliding the clipped portion of the one end portion.

5. The power generator claimed in claim 4, wherein the clipped portions of the one end portions of the first spring portions are configured to be slid by rotating the pair of leaf springs relative to the housing around the central axis of the third circular portion.

6. The power generator claimed in claim 5, further comprising a manipulating mechanism for rotating the pair of leaf springs relative to the housing.

7. The power generator claimed in claim 4, wherein the clipping members are integrally formed with the housing.

8. The power generator claimed in claim 2, wherein the second spring constant adjuster has a clearance adjuster for adjusting a clearance between the third circular portions of the leaf springs and is configured to be capable of adjusting the spring constants of the second spring portions by changing the clearance between the third circular portions of the leaf springs with the clearance adjuster.

9. The power generator claimed in claim 8, wherein the clearance adjuster has a spacer fixed on the third circular portion of one of the leaf springs, a clearance adjusting member for adjusting a clearance between the spacer and the magnet and an elastic member disposed between the spacer and the magnet.

10. The power generator claimed in claim 9, wherein a vibrating system due to the elastic member is provided in the power generator, and
wherein the vibrating system has a resonant frequency larger than five times a frequency of vibration utilized for power generation of the power generator.

11. The power generator claimed in claim 9, wherein the elastic member is a spring washer or a wave washer.
